(19) United States
(12) Patent Application Publication
(10) Pub. No.: US 2007/0041278 A1
(43) Pub. Date: Feb. 22, 2007

(54) Disk reproducing apparatus

(75) Inventor: Satoshi Tsujimoto, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/505,887

(22) Filed: Aug. 18, 2006

(30) Foreign Application Priority Data
Aug. 22, 2005 (JP) P2005-239783

(51) Int. Cl. H04B 1/20

(52) U.S. Cl. 369/1

(57) ABSTRACT

A disk reproducing apparatus that includes: an acquisition unit that acquires predetermined information recorded on an optical disk; a determination unit that determines whether or not the predetermined information has speaker information; a first audio output unit that, when the predetermined information has the speaker information, outputs the audio signal based on the speaker information; a display unit that, when the predetermined information has no speaker information, displays a user setting screen for setting a number of audio signal output channels; a setting unit that selects an output channel on the user setting screen and sets a number of audio signal output channels; and a second audio output unit that outputs the audio signal based on the setting of the number of output channels set by the setting unit.

### BACKGROUND OF THE INVENTION

1. Field of the Invention

The present invention relates to a disk reproducing apparatus which reproduces and outputs a video/audio signal recorded on an optical disk and, in particular, to a disk reproducing apparatus for which, in a case in which HDMI (High-Definition Multimedia Interface) video/audio signal reproduction information E-EDID (Enhanced-Extended Display Identification Data) has no speaker information, a user can set a number of audio signal output channels.

2. Description of the Related Art

In general, in a case in which E-EDID has speaker information, by connecting it to a receiver compatible with 5.1 channels and reproducing a 5.1 channel HDMI audio signal recorded on an optical disk, it is possible to listen to reproduced HDMI audio on the 5.1 channels. However, as the speaker information is not an indispensable condition, the E-EDID has no speaker information in some cases and, in a case in which the E-EDID has no speaker information, even though the HDMI audio signal recorded on the optical disk is a 5.1 channel audio signal, the HDMI audio signal is output downmixed to a 2 channel audio output. For this reason, there has been a problem wherein, in the case in which the E-EDID has no speaker information, even by connecting it to the receiver compatible with the 5.1 channels and reproducing the 5.1 channel audio signal recorded on the optical disk, the 5.1 channel HDMI audio signal is downmixed to 2 channels and output from only right and left speakers.

As the background art, there has been one which is configured in such a way as to detect speaker information of a speaker system, extract signal information including the number and kind of audio channels and, based on the extracted speaker information and the extracted signal information, select a signal processing of each audio channel corresponding to the speaker system and the signal information (for example, refer to JP-A-2003-204600).

Also, there has been one which is configured in such a way as to control an output device based on output control information for controlling an output to an audio signal output line, transmit the output control information to an exterior, receive output control information, determine an audio signal output channel based on the received output control information, and output an audio signal corresponding to the determined output channel from acquired audio information (for example, refer to JP-A-2004-96238). Also, there has been one which is configured in such a way as to receive a supply of conversion information from an input audio signal channel configuration and an output channel configuration connected with a speaker and, based on the conversion information, output an audio signal on each output channel, which corresponds to the output channel configuration, from an audio signal on each input audio signal channel (for example, refer to JP-A-2004-312484).

### SUMMARY OF THE INVENTION

The first one described in the background art can detect speaker information of a speaker system, extract signal information including the number and kind of audio channels and, based on the extracted speaker information and the extracted signal information, select a signal processing of each audio channel corresponding to the speaker system and the signal information. However, it is configured in such a way as to detect the speaker information of the connected speaker system, and process and output an audio signal in accordance with the connected speaker system, and is not configured in such a way that, in the case in which the E-EDID has no speaker information, a user can set a number of HDMI audio signal output channels to suit his or her own preferences.

Also, the next one can control an output device based on output control information for controlling an output to an audio signal output line, transmit the output control information to an exterior, receive output control information, determine an audio signal output channel based on the received output control information, and output an audio signal corresponding to the determined output channel from acquired audio information. However, it is configured in such a way as to determine a number of audio signal output channels based on the output control information of an amplifier which outputs a multi audio signal, and downmix it according to need, and is not configured in such a way that, in the case in which the E-EDID has no speaker information, the user can set a number of HDMI audio signal output channels to suit his or her own preferences.

Also, the next one can receive a supply of conversion information from an input audio signal channel configuration and an output channel configuration connected with a speaker and, based on the conversion information, output an audio signal on each output channel, which corresponds to the output channel configuration, from an audio signal on each input audio signal channel. However, it is configured in such a way as to form an output channel audio signal in accordance with the input signalchannelconfigurationandtheoutputchannelconfiguration, and is not configured in such a way that, in the case in which the E-EDID has no speaker information, the user can set a number of HDMI audio signal output channels to suit his or her own preferences.

Theinventionhasbeenconceivedwithanobjectofproviding a disk reproducing apparatus for which, in a case in which an HDMI audio signal recorded on an optical disk can be reproduced and output on 5.1 channels, even in the event that E-EDID has no speaker information, a user can set a number of HDMI audio signal output channels to suit his or her own preferences.

According to an aspect of the invention, there is provided a disk reproducing apparatus which reproduces and outputs a video/audio signal recorded on an optical disk, including: acquisition means which acquires E-EDID of an HDMI audio signal recorded on the optical disk; determination means which determines whether or not the E-EDID acquired by the acquisition means has speaker information; first audio output means which, in the event that the determination means has determined that the E-EDID acquired by the acquisition means has the speaker information, outputs the HDMI audio signal based on the speaker information of the E-EDID acquired by the acquisition means; display means which, in the event that the determination means has determined that the E-EDID acquired by the acquisition means has no speaker information, displays a user setting screen for setting a. number of HDMI audio signal output channels; setting means which selects an output channel on the user setting screen displayed by the display means, and sets a number of HDMI audio signal output channels; and second audio output means which outputs the HDMI audio signal based on the setting of the number of output channels by the setting means.

The second audio output means is preferably configured in such a way as to, in the case in which the setting means has set the number of HDMI audio signal output channels, output the HDMI audio signal on the number of output channels set by the setting means.

Also, the second audio output means is preferably configured in such a way as to, in the case in which the setting means sets no additional number of HDMI audio signal output channels, output the HDMI audio signal by downmixing it to the preset “2 channels”.

By these means, in the case in which the HDMI audio signal recorded on the optical disk can be reproduced and output on 5.1 channels, even in the event that the E-EDID has no speaker information, the user can set a number of HDMI audio signal output channels to suit his or her own preferences.

The aspect of the invention is configured to acquire E-EDID of an HDMI audio signal recorded on the optical disk; determine whether or not the acquired E-EDID has speaker information; in the event that it has been determined that the acquired E-EDID has the speaker information, output the HDMI audio signal based on the speaker information of the acquired E-EDID; in the event that it has been determined that the acquired E-EDID has no speaker information, display a user setting screen for setting a number of HDMI audio signal output channels; and, in a case in which an output channel on the displayed user setting screen has been selected and thus the number of HDMI audio signal output channels has been set, output the HDMI audio signal on the set number of output channels, while, in a case in which no output channel on the displayed user setting screen is selected and thus no number of HDMI audio signal output channels is set, output the HDMI audiosignal bydownmixing it to preset“2 channels”. Therefore, in the case in which the HDMI audio signal recorded on the optical disk can be reproduced and output on the 5.1 channels, even in the event that the E-EDID has no speaker information, the user can set a number of HDMI audio signal output channels to suit his or her own preferences.

The aspect of the invention is configured to acquire E-EDID of an HDMI audio signal recorded on an optical disk; determine whether or not the acquired E-EDID has speaker information; in the event that it has been determined that the acquired E-EDID has the speaker information, output the HDMI audio signal based on the speaker information of the acquired E-EDID; in the event that it has been determined that the acquired E-EDID has no speaker information, display a user setting screen for setting a number of HDMI audio signal output channels; and output the HDMI audio signal based on a setting of an output channel on the displayed user setting screen. Therefore, in the case in which the HDMI audio signal recorded on the optical disk can be reproduced and output on the 5.1 channels, even in the event that the E-EDID has no speaker information, the user can set a number of HDMI audio signal output channels to suit his or her own preferences.

The aspect of the invention is configured to, in the case in which the output channel on the displayed user setting screen has been selected and thus the number of HDMI audio signal output channels has been set, output the HDMI audio signal on the set number of output channels. Therefore, in the case in which the HDMI audio signal recordedontheopticaldiskcanbereproduced and output on the 5.1 channels, even in the event that the E-EDID has no speaker information, the user can set a number of HDMI audio signal output channels to suit his or her own preferences.

The aspect of the invention is configured to, in the case in which no additional output channel on the displayed user setting screen has been selected and thus no number of HDMI audio signal output channels has been added, output the HDMI audio signal by downmixing it to the preset “2 channels”. Therefore, the user, in a case of selecting no number of HDMI audio signal output channels, can output the HDMI audio signal by downmixing it to the 2 channels.

### BRIEF DESCRIPTION OF THE DRAWINGS

FIG. 1 is a block diagram showing a configuration of a disk reproducing apparatus according to an embodiment of the invention;

FIG. 2 is an illustration showing a remote control unit of the disk reproducing apparatus according to the embodiment of the invention;

FIG. 3 is a diagram showing a display example of a user setting screen of the disk reproducing apparatus according to the embodiment of the invention; and

FIG. 4 is a flowchart showing an operation of the disk reproducing apparatus according to the embodiment of the invention.

### DETAILED DESCRIPTION OF THE PREFFERED EMBODIMENTS

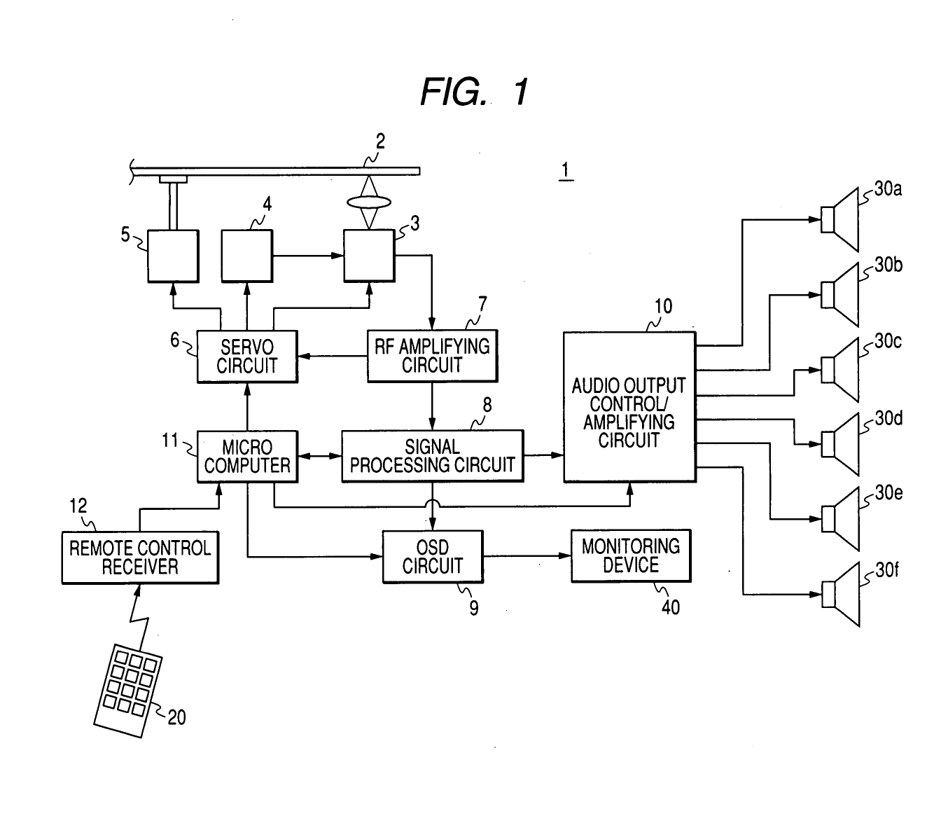

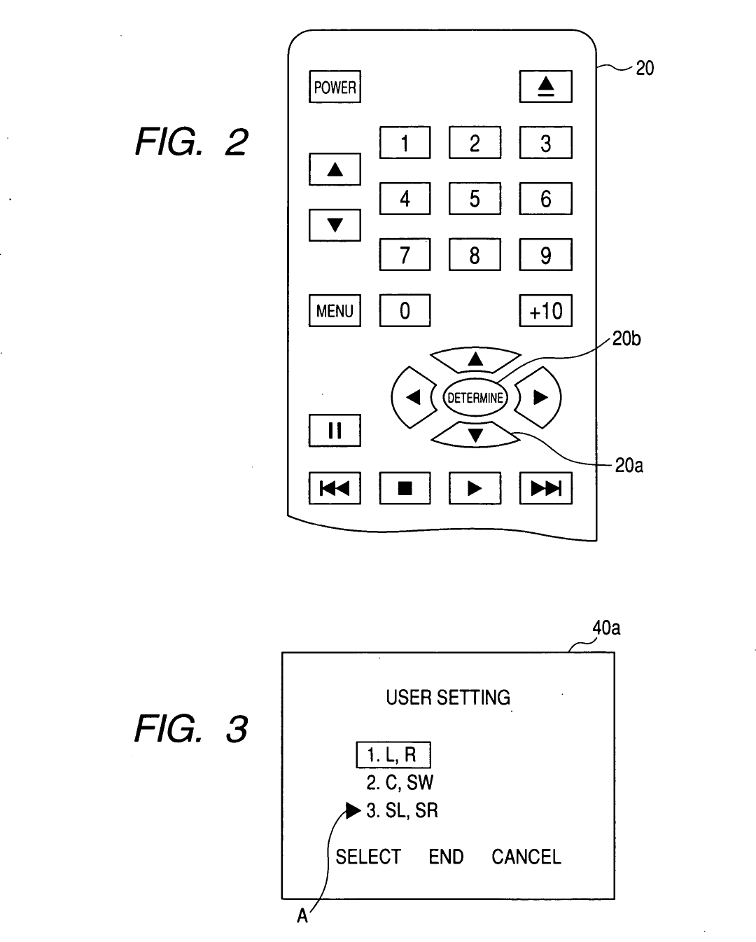

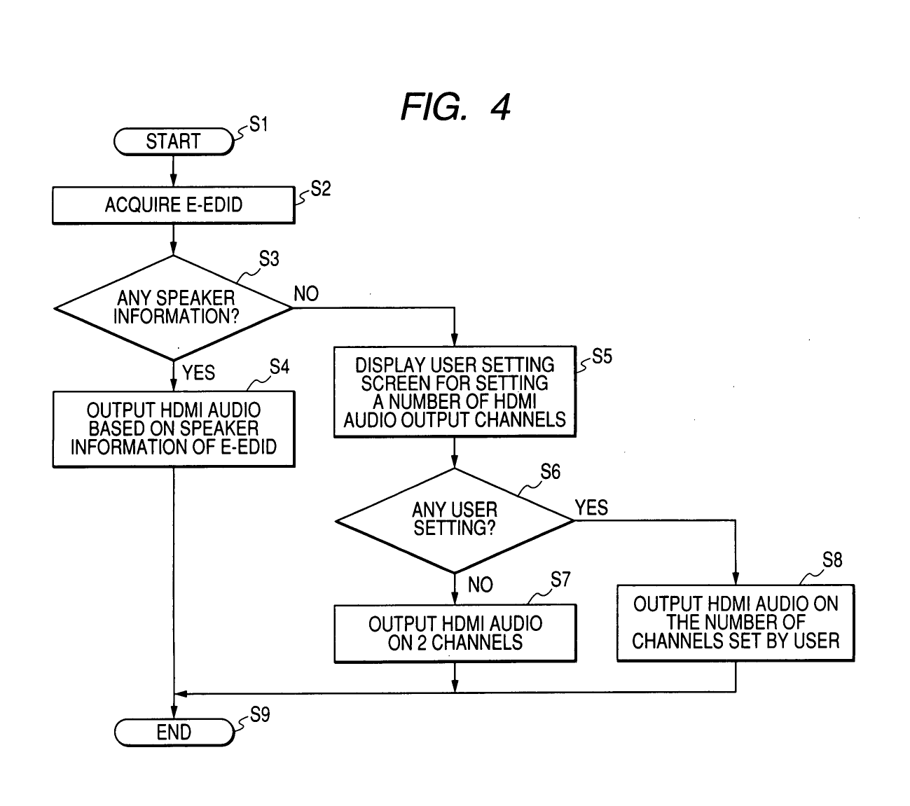

Hereafter, a detailed description will be given, while referring to the drawings, of an embodiment of the invention. FIG. 1 is a block diagram showing a configuration of a disk reproducing apparatus according to an embodiment of the invention. FIG. 2 is an illustration showing a remote control unit of the disk reproducing apparatus according to the embodiment of the invention. FIG. 3 is a diagram showing a display example of a user setting screen of the disk reproducing apparatus according to the embodiment of the invention. FIG. 4 is a flowchart showing an operation of the disk reproducing apparatus according to the embodiment of the invention.

First, a description will be given based on FIG. 1, the block diagram showing a configuration of the disk reproducing apparatus according to the embodiment of the invention.

The disk reproducing apparatus 1 includes an optical pickup 3, a thread motor 4, a spindle motor 5, a servo circuit 6, an RF amplifying circuit 7, a signal processing circuit 8, an OSD (On-Screen Character Display) circuit 9, an audio output control/amplifying circuit 10, a micro computer 11 and a remote control receiver 12. The optical pickup 3, by irradiating an optical disk 2 with a laser beam, detects a reflecting light therefrom and reads a video/audio signal recorded on the optical disk 2. The thread motor 4 moves the optical pickup 3 in a radial direction of the optical disk 2. The spindle motor 5 rotates the optical disk 2. The servo circuit 6 servo-controls a rotation direction and rotation speed of the thread motor 4 and a rotation speed of the spindle motor 5 and, based on a tracking error signal and focus error signal detected by the optical pickup 3, servo-controls a tracking and focus of the optical pickup 3. The RF amplifying circuit 7 amplifies an RF (Radio Frequency) signal of the video/audio signal read by the optical pickup 3. The signal processing circuit 8 demodulates the video/audio signal, which has been read by the optical pickup 3, by synchronously detecting it based on a reference clock, corrects an error of the demodulated video/audio signal, extends the video/audio signal compressed based on a prescribed compression method, and decodes and reproduces the video/audio signal. The OSD (On-Screen Character Display) circuit 9 superimposes a character information signal on the video signal, and displays character information on a screen of a monitoring device 40. The audio output control/amplifying circuit 10 controls a number of output channels on which the audio signal is to be output to a left speaker 30a, a right speaker 30b, a center speaker 30c, a subwoofer speaker 30d, a surround left speaker 30e and/or a surround right speaker 30f, and amplifies and outputs the audio signal on a prescribed number of channels. The micro computer 11 controls the whole system of the disk reproducing apparatus 1. The remote control receiver 12 receives a remote control signal of an infrared signal transmitted from the remote control unit 20, and converts the remote control signal into a prescribed electric signal.

Also, the remote control unit 20, as shown in FIG. 2, is provided with a plurality of operation keys, such as a cursor key 20a for selecting a selection item displayed on the screen of the monitoring device 40, and a determine key 20b for determining the selection of the selection item selected by the cursor key 20a, wherein a configuration is such that the disk reproducing apparatus 1 can be operated as desired by operating these keys.

Hereafter, a description will be given of an operation of the disk reproducing apparatus configured as described heretofore.

When an instruction to reproduce the optical disk 2 loaded into the disk reproducing apparatus 1 is given by an operation of the operation keys of the remote control unit 20, the micro computer 11 sends a control signal to the servo circuit 6, drives the spindle motor to rotate the optical disk 2, drives the thread motor 4 to move the optical pickup in the radial direction of the optical disk 2, turns on a tracking servo and focus servo of the optical pickup 3, reads reproduction information E-EDID of an HDMI audio signal recorded on the optical disk 2, and acquires the reproduction information E-EDID of the HDMI audio signal which it has been instructed to reproduce.

When having acquired the HDMI audio signal reproduction information E-EDID, the micro computer 1 determines whether or not the acquired reproduction information E-EDID has speaker information. In the event that the acquired reproduction information E-EDID has the speaker information, the micro computer 1 sends a control signal to the audio output control/amplifying circuit 10 and, based on the speaker information of the acquired reproduction information E-EDID, outputs the HDMI audio signal to the left speaker 30a, the right speaker 30b, the center speaker 30c, the subwoofer speaker 30d, the surround left speaker 30e and/or the surround right speaker 30f.

Also, in the event that the acquired reproduction information E-EDID has no speaker information, the microcomputer 11 sends the character information and a control signal to the OSD circuit 9, wherein a user setting screen for setting a number of HDMI audio signal output channels is displayed on the screen 40a of the monitoring device 40 (refer to FIG. 3). In FIG. 3, a selected speaker is indicated by a frame, and the position of a cursor A for selecting a speaker is shown. “1. LEFT SPEAKER L, RIGHT SPEAKER R” indicated by the frame is a preset default value.

By operating the cursor key 20a and determine key 20b of the remote control unit 20, in addition to the default value “1. LEFT SPEAKER L, RIGHT SPEAKER R” displayed on the user setting screen for setting the number of HDMI audio signal output channels displayed on the screen 40a of the monitoring device 40, either “2. CENTER SPEAKER C, SUBWOOFER SPEAKER SW” or “3. SURROUND LEFT SPEAKER SL, SURROUND RIGHT SPEAKER SR”, or both “2. CENTER SPEAKER C, SUBWOOFER SPEAKER SW” and “3. SURROUND LEFT SPEAKER SL, SURROUND RIGHT SPEAKER SR” are selected, and thus the number of HDMI audio signal output channels is set. In this case, the microcomputer 11 sends the control signal to the audio output control/amplifying circuit 10, wherein the audio output control/amplifying circuit 10 outputs the HDMI audio signal to the left speaker 30a, right speaker 30b, center speaker 30c, subwoofer speaker 30d, surround left speaker 30e and/or surround right speaker 30f on the set number of channels.

Also, in a case in which no additional HDMI audio signal output channel displayed on the screen 40a of the monitoring device 40 is selected and thus no number of HDMI audio signal output channels is added, when a prescribed user setting screen display time has elapsed, the microcomputer 11 sends a control signal to the audio output control/amplifying circuit 10, wherein the audio output control/amplifying circuit 10 outputs the HDMI audio signal to the left speaker 30a and the right speaker 30b by downmixing it to preset default “2 channels”.

Also, a description will be given based on FIG. 4, the flowchart showing an operation of the disk reproducing apparatus according to the embodiment of the invention.

When an instruction is given to reproduce the optical disk loaded in the disk reproducing apparatus, the operation moves from step S1 to step S2, and the reproduction information E-EDID of the HDMI audio signal recorded on the optical disk is acquired in step S2, whereupon the operation moves to step S3.

In step S3, it is determined whether or not the acquired reproduction information E-EDID has speaker information. If the acquired reproduction information E-EDID has the speaker information, the operation moves to step S4, while, if the acquired reproduction information E-EDID has no speaker information, the operation moves to step S5.

In step S4, the HDMI audio signal is output based on the speaker information of the reproduction information E-EDID, whereupon the operation moves to step S9 to end the process.

In step S5, the user setting screen for setting the number of HDMI audio signal output channels is displayed, whereupon the operation moves to step S6.

In step S6, it is determined whether or not an HDMI audio signal output channel on the user setting screen has been selected and thus a number of HDMI audio signal output channels has been set. If the HDMI audio signal output channel on the user setting screen has been selected and thus the number of HDMI audio signal output channels has been set, the operation moves to step S8. If no additional HDMI audio signal output channel on the user setting screen is selected and thus no number of HDMI audio signal output channels is set, the operation moves to step S7.

In step S7, the HDMI audio signal is downmixed to the preset default “2 channels” and output on the 2 channels, whereupon the operation moves to step S9 to end the process.

In step S8, the HDMI audio signal output channel is selected on the user setting screen, and the HDMI audio signal is output on the set number of HDMI audio signal output channels, whereupon the operation moves to step S9 to end the process.

Although a detailed description has heretofore been given of a best mode for carrying out the invention, the invention is not limited thereto but, needless to say, can be modified and improved within the range of common knowledge of those skilled in the art.

What is claimed is:

1. A disk reproducing apparatus that reproduces and outputs a video/audio signal recorded on an optical disk, comprising:
acquisition means that acquires E-EDID of an HDMI audio signal recorded on the optical disk;
determination means that determines whether or not the E-EDID acquired by the acquisition means has speaker information;
first audio output means that, in the event that the determination means has determined that the E-EDID acquired by the acquisition means has the speaker information, outputs the HDMI audio signal based on the speaker information of the E-EDID acquired by the acquisition means;
display means that, in the event that the determination means has determined that the E-EDID acquired by the acquisition means has no speaker information, displays a user setting screen for setting a number of HDMI audio signal output channels;
setting means that selects an output channel on the user setting screen displayed by the display means and sets a number of HDMI audio signal output channels; and
second audio output means that, in a case in which the setting means has set the number of HDMI audio signal output channels, outputs the HDMI audio signal on the number of output channels set by the setting means, while, in a case in which the setting means sets no number of HDMI audio signal output channels, outputs the HDMI audio signal by downmixing it to preset “2 channels”.

2. A disk reproducing apparatus that reproduces and outputs a video/audio signal recorded on an optical disk, comprising:
acquisition means that acquires E-EDID of an HDMI audio signal recorded on the optical disk;
determination means that determines whether or not the E-EDID acquired by the acquisition means has speaker information;
first audio output means that, in the event that the determination means has determined that the E-EDID acquired by the acquisition means has the speaker information, outputs the HDMI audio signal based on the speaker information of the E-EDID acquired by the acquisition means;
display means that, in the event that the determination means has determined that the E-EDID acquired by the acquisition means has no speaker information, displays a user setting screen for setting a number of HDMI audio signal output channels;
setting means that selects an output channel on the user setting screen displayed by the display means and sets a number of HDMI audio signal output channels; and
second audio output means that outputs the HDMI audio signal based on the setting of the number of output channels set by the setting means.

3. The disk reproducing apparatus according to claim 2, wherein the second audio output means is audio output means that, in the case in which the setting means has set the number of HDMI audio signal output channels, outputs the HDMI audio signal on the number of output channels set by the setting means.

4. The disk reproducing apparatus according to claim 2, wherein the second audio output means is audio output means that, in the case in which the setting means sets no number of HDMI audio signal output channels, outputs the HDMI audio signal by downmixing it to the preset “2 channels”.

5. A disk reproducing apparatus that reproduces and outputs a video/audio signal recorded on an optical disk, comprising:
an acquisition unit that acquires predetermined information recorded on the optical disk;
a determination unit that determines whether or not the predetermined information acquired by the acquisition unit has speaker information;
a first audio output unit that, in the event that the determination unit has determined that the predetermined information acquired by the acquisition unit has the speaker information, outputs the audio signal based on the speaker information of the predetermined information acquired by the acquisition unit;
a display unit that, in the event that the determination unit has determined that the predetermined information acquired by the acquisition unit has no speaker information, displays a user setting screen for setting a number of audio signal output channels;
a setting unit that selects an output channel on the user setting screen displayed by the display unit and sets a number of audio signal output channels; and
a second audio output unit that outputs the audio signal based on the setting of the number of output channels set by the setting unit.
